(19) United States
(12) Patent Application Publication
(10) Pub. No.: US 2009/0191389 A1
(43) Pub. Date: Jul. 30, 2009

(54) TRANSPARENT CONDUCTORS THAT EXHIBIT MINIMAL SCATTERING, METHODS FOR FABRICATING THE SAME, AND DISPLAY DEVICES COMPRISING THE SAME

(75) Inventors: James V. Guiheen, Madison, NJ (US); Michael Paukshto, Forest City, CA (US); Peter Smith, Long Valley, NJ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 12/264,015

(22) Filed: Nov. 3, 2008

Related U.S. Application Data
(60) Provisional application No. 61/024,600, filed on Jan. 30, 2008.

(51) Int. Cl. B32B 7/02; B05D 5/12

(52) U.S. Cl. 428/212; 427/58

(57) ABSTRACT

Transparent conductors that exhibit minimal scattering, methods for fabricating such transparent conductors, and display devices comprising such transparent conductors are provided. In one exemplary embodiment, a transparent conductor comprises a substrate having an effective refractive index n₁, an over layer overlying the substrate and having an effective refractive index n₃, and a transparent conductive coating interposed between the substrate and the over layer. The transparent conductive coating comprises a plurality of conductive components and a matrix material that together have an effective refractive index n₂ in the range of about \sqrt{n₁×n₃}−Δ≦n₂≦\sqrt{n₁×n₃}+Δ, wherein Δ is an optimization factor within the range of about 0 to about 0.3.

### CROSS-REFERENCES TO RELATED APPLICATIONS

This application claims the benefit of U.S. Provisional Application No. 61/024,600, filed Jan. 30, 2008.

### FIELD OF THE INVENTION

The present invention generally relates to transparent conductors, methods for fabricating transparent conductors, and display devices comprising transparent conductors. More particularly, the present invention relates to transparent conductors that exhibit minimal scattering and enhanced transmissivity, methods for fabricating such transparent conductors, and display devices that comprise such transparent conductors.

### BACKGROUND OF THE INVENTION

Over the past few years, there has been an explosive growth of interest in research and industrial applications for transparent conductors. A transparent conductor typically includes a transparent substrate upon which is disposed a coating or film that is transparent yet electrically conductive. This unique class of conductors is used, or is considered being used, in a variety of applications, such as solar cells, antistatic films, gas sensors, organic light-emitting diodes, liquid crystal and high-definition displays, and electrochromic and smart windows, as well as architectural coatings.

Conventional methods for fabricating transparent conductive coatings on transparent substrates include dry and wet processes. In dry processes, plasma vapor deposition (PVD) (including sputtering, ion plating and vacuum deposition) or chemical vapor deposition (CVD) is used to form a conductive transparent film of a metal oxide, such as indium-tin mixed oxide (ITO), antimony-tin mixed oxide (ATO), fluorine-doped tin oxide (FTO), and aluminum-doped zinc oxide (Al-ZO). The films produced using dry processes have both good transparency and good conductivity. However, these films, particularly ITO, are expensive and require complicated apparatuses that result in poor productivity. Other problems with dry processes include difficult application results when trying to apply these materials to continuous and/or large substrates. In conventional wet processes, conductive coatings are formed using the above-identified electrically conductive powders mixed with liquid additives. In all of these conventional methods using metal oxides and mixed oxides, the materials suffer from supply restriction, lack of spectral uniformity, poor adhesion to substrates, and brittleness.

Alternatives to metal oxides for transparent conductors include conductive components such as, for example, silver nanowires and carbon nanotubes. Transparent conductors formed of such conductive components demonstrate transparency and conductivity equal to, if not superior to, those formed of metal oxides. In addition, these transparent conductors exhibit mechanical durability that metal-oxide transparent conductors do not. Accordingly, these transparent conductors can be used in a variety of applications, including flexible display applications. However, these transparent conductors often suffer from unacceptable lateral light leakage, also termed “scattering” or “haze,” wherein light entering the conductor at a direction is refracted substantially laterally from the direction, causing the conductor to appear hazy. Haze is undesirable in many types of optical devices, such as, for example, liquid crystal displays.

Accordingly, it is desirable to provide transparent conductors that exhibit minimal scattering and enhanced transmissivity. It also is desirable to provide methods for fabricating transparent conductors that exhibit minimal scattering and enhanced transmissivity. It also is desirable to provide display devices comprising such transparent conductors. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Exemplary embodiments of transparent conductors that exhibit minimal scattering, methods for fabricating such transparent conductors, and display devices comprising such transparent conductors are provided herein. In accordance with one exemplary embodiment of the present invention, a transparent conductor comprises a substrate having an effective refractive index n₁, an over layer overlying the substrate and having an effective refractive index n₃, and a transparent conductive coating interposed between the substrate and the over layer. The transparent conductive coating comprises a plurality of conductive components and a matrix material that together have an effective refractive index n₂ in the range of about \sqrt{n₁×n₃}−Δ≦n₂≦\sqrt{n₁×n₃₀}+Δ, wherein Δ is an optimization factor within the range of about 0 to about 0.3.

A method for fabricating a transparent conductor is provided in accordance with an exemplary embodiment of the present invention. The method comprises the steps of providing a substrate having an effective refractive index n₁ and forming a transparent conductive coating on the substrate. The transparent conductive coating comprises a plurality of conductive components and a matrix material. An over layer is formed overlying the plurality of conductive components and the matrix material. The over layer has an effective refractive index n₃. The transparent conductive coating has an effective refractive index n₂ in the range of about \sqrt{n₁×n₃}−Δ≦n₂≦\sqrt{n₁×n₃}+Δ, wherein Δ is an optimization factor in the range of about 0 to about 0.3.

A display device is provided in accordance with an exemplary embodiment of the present invention. The display device comprises a first functional layer, a second functional layer, and a transparent conductor interposed between the first functional layer and the second functional layer. The transparent conductor comprises a substrate having an effective refractive index n₁, an over layer overlying the substrate and having an effective refractive index n₃, and a transparent conductive coating interposed between the substrate and the over layer. The transparent conductive coating comprises a plurality of conductive components and a material that together have an effective refractive index n₂ in the range of about \sqrt{n₁×n₃}−Δ≦n₂≦\sqrt{n₁×n₃}+Δ, wherein Δ is an optimization factor in the range of about 0.01 to about 0.3.

### BRIEF DESCRIPTION OF THE DRAWINGS

The present invention will hereinafter be described in conjunction with the following drawing figures, wherein like numerals denote like elements, and wherein:

FIG. 1 is a cross-sectional view of a transparent conductor with a transparent conductive coating having a matrix material component in accordance with an exemplary embodiment of the present invention;

FIG. 2 is a flowchart of a method for fabricating a transparent conductor in accordance with an exemplary embodiment of the present invention;

FIG. 3 is a flowchart of a method for fabricating a transparent conductive coating, as used in the method of FIG. 2, wherein the transparent conductive coating utilizes a matrix material component in accordance with an exemplary embodiment of the present invention;

FIG. 4 is a flowchart of a method for fabricating a transparent conductive coating, as used in the method of FIG. 2, wherein the transparent conductive coating utilizes a matrix material component in accordance with another exemplary embodiment of the present invention;

FIG. 5 is a cross-sectional view of a transparent conductor with a transparent conductive coating having a refractive index-adjusting material in accordance with another exemplary embodiment of the present invention;

FIG. 6 is a flowchart of a method for fabricating a transparent conductive coating as used in the method of FIG. 2, wherein the transparent conductive coating utilizes a refractive index-adjusting material component in accordance with an exemplary embodiment of the present invention;

FIG. 7 is a flowchart of a method for fabricating a transparent conductive coating as used in the method of FIG. 2, wherein the transparent conductive coating utilizes a refractive index-adjusting material component in accordance with another exemplary embodiment of the present invention; and

FIG. 8 is a cross-sectional view of a display device utilizing the transparent conductor of FIG. 1 or FIG. 5.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Transparent conductors described herein exhibit minimal scattering, thus minimizing haze apparent in the conductors and in display devices that utilize the conductors and enhancing the transmissivity thereof. In one exemplary embodiment of the present invention, the transparent conductors are formed with a transparent conductive coating that is a quarter-wave layer that corresponds to a wavelength in the spectral interval of about 380 nm to about 460 nm and that has an effective refractive index that is tuned to be in the interval between the effective refractive indices of the material layers between which the transparent conductive coating is interposed. In another exemplary embodiment, scattering is minimized by the utilization of a transparent conductive coating that comprises conductive components and a refractive index-adjusting material. The refractive index-adjusting material has a refractive index that corresponds to the effective refractive indices of the materials between which the transparent conductive coating is interposed.

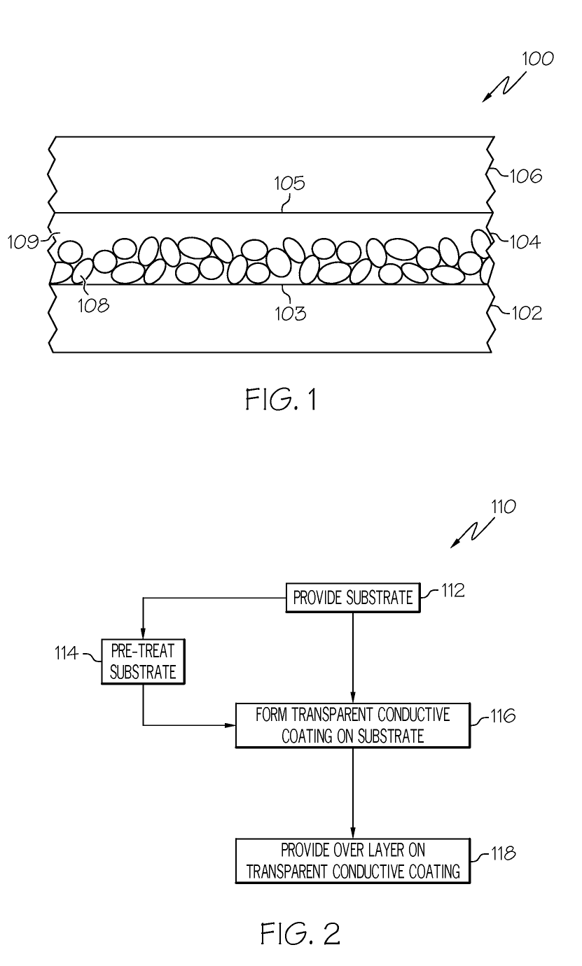

A transparent conductor 100 in accordance with an exemplary embodiment of the present invention is illustrated in FIG. 1. The transparency of the transparent conductor 100 can be characterized by its light transmittance (defined by ASTM D1003), that is, the percentage of incident light transmitted through the conductor, and its surface resistivity. Electrical conductivity and electrical resistivity are inverse quantities. Very low electrical conductivity corresponds to very high electrical resistivity. No electrical conductivity refers to electrical resistivity that is above the limits of the measurement equipment available. In one exemplary embodiment of the invention, the transparent conductor 100 has a total light transmittance of no less than about 50%. In another exemplary embodiment of the invention, the transparent conductor 100 has a surface resistivity in the range of about 10¹ to about 10¹² ohms/square (Ω/sq). In another exemplary embodiment of the invention, the transparent conductor 100 has a surface resistivity in the range of about 10¹ to about 10³ n/sq. In this regard, the transparent conductor 100 may be used in various applications such as display devices (for example, flat panel displays, touch panels, flexible displays, electrophoretic displays, organic LED displays, plasma displays, electroluminescent displays, and the like), photovoltaic devices, electroluminescent lamps, electrochromic windows, thermal control films, microelectronics, and the like.

The transparent conductor 100 comprises a transparent substrate 102 having an effective refractive index indicated by the variable “n₁,” and an over layer 106 having an effective refractive index indicated by the variable “n₃”. As used herein, the term “refractive index” means the real part of the “complex refractive index” of a material. The real part of the complex refractive index relates to the reflective property of the material, as denoted by the “refractive index”, while the imaginary part of the complex refractive index relates to the absorption property of the material, as denoted by the “absorption coefficient.” For the special case of non-absorbing materials, such as, for example, glass, the absorption coefficient is effectively equal to zero and the complex refractive index coincides with the refractive index. A transparent conductive coating 104 is interposed between the transparent substrate 102 and the over layer 106. As used herein, the term “over layer” refers to a layer or layers of material disposed adjacent to a surface 105 of the transparent conductive coating 104 opposite a surface 103 against which the substrate is disposed. As described in more detail below, the transparent conductive coating 104 comprises conductive components 108 and a matrix material 109. The transparent conductive coating 104 is a quarter-wave layer corresponding to the spectral interval of about 380 nm to about 460 nm. By definition, a quarter-wave layer of material with a refractive index n is an optical layer with thickness “d” defined by equation (1):

$$d = \frac{( 2 \times k + 1 ) \times λ}{4} \times \frac{1}{n} , \qquad ( 1 )$$

where “k” is an integer number (k=0, 1, 2, . . . ), “λ” is the wavelength for which the layer has an optimal transmissivity, and “n” is the refractive index of the layer. The preferable thickness for minimal material usage and maximal transmissivity corresponds to k=0. Thus, thickness “d” is the optimum thickness of transparent conductive coating 104 for maximum transmissivity of transparent conductor 100 at wavelength “λ” if n=\sqrt{nₛ₁×nₛ₂}, where “nₛ₁” is the effective refractive index of a layer disposed against one surface of the quarter-wave layer and “nₛ₂” is the effective refractive index of a layer disposed against the opposite surface of the quarter-wave layer. The spectral interval of about 380 nm to about 460 nm is the blue spectral interval and conductive components such as carbon nanotubes and silver nanowires exhibit maximum absorption in the blue region compared with the spectral interval of about 380 nm to about 780 nm (that is, the entire visible spectrum). Thus, if transmissivity of carbon nanotubes and silver nanowires of the transparent conductor 100 may be enhanced or optimized in this blue spectral interval, transmissivity across the visible spectral interval of about 380 nm to about 780 nm also will be enhanced or optimized. Accordingly, to minimize scattering and enhance transmissivity of transparent conductor 100, the transparent conductive coating 104 is configured as a quarter-wave layer having a refractive index “n₂” defined by equation (2):

n₂=\sqrt{n₁×n₃}±Δ (2),

where Δ is an optimization factor in the range of about 0 to about 0.3, and corresponds to a wavelength λ in the spectral interval of about 380 nm to about 460 nm. The optimization factor is a predetermined factor that is selected based on actual production factors. As Δ approaches 0, the refractive index n₂ approaches \sqrt{n₁×n₃} and the transparent conductive coating approaches an optimum transmissivity with zero reflectance at wavelength λ.

Referring to FIG. 2, a method 110 for fabricating a transparent conductor that exhibits minimal scattering, such as the transparent conductor 100 of FIG. 1, comprises an initial step of providing a transparent substrate having an effective refractive index n₁ (step 112). The term “substrate”, as used herein, includes any suitable surface upon which the compounds and/or compositions described herein are applied and/or formed. The transparent substrate may comprise any rigid or flexible transparent material layer having an effective refractive index n₁ or may comprise multiple sub-layers of rigid or flexible transparent material that, combined, have an effective refractive index n₁. In one exemplary embodiment of the invention, the transparent substrate has a total light transmittance of no less than about 75%. The light transmittance of the transparent substrate 102 may be less than, equal to, or greater than the light transmittance of the transparent conductive coating 104. Examples of transparent materials suitable for use as a transparent substrate include glass, ceramic, metal, paper, polycarbonates, acrylics, silicon, and compositions containing silicon such as crystalline silicon, polycrystalline silicon, amorphous silicon, epitaxial silicon, silicon dioxide (SiO₂), silicon nitride and the like, other semiconductor materials and combinations, ITO glass, ITO-coated plastics, polymers including homopolymers, copolymers, grafted polymers, polymer blends, polymer alloys and combinations thereof, composite materials, or multi-layer structures thereof. Examples of suitable transparent polymers include polyesters such as polyethylene terephthalate (PET) and polyethylene naphthalate (PEN), polyolefins, particularly the metallocened polyolefins, such as polypropylene (PP) and high-density polyethylene (HDPE) and low-density polyethylene (LDPE), polyvinyls such as plasticized polyvinyl chloride (PVC), polyvinylidene chloride, cellulose ester bases such as triacetate cellulose (TAC) and acetate cellulose, polycarbonates, poly(vinyl acetate) and its derivatives such as poly(vinyl alcohol), acrylic and acrylate polymers such as methacrylate polymers, poly(methyl methacrylate) (PMMA), methacrylate copolymers, polyamides and polyimides, polyacetals, phenolic resins, aminoplastics such as urea-formaldehyde resins, and melamine-formaldehyde resins, epoxide resins, urethanes and polyisocyanurates, furan resins, silicones, casesin resins, cyclic thermoplastics such as cyclic olefin polymers, styrenic polymers, fluorine-containing polymers, polyethersulfone, and polyimides containing an alicyclic structure.

In an optional embodiment of the present invention, the substrate may be pre-treated to facilitate the deposition of components of the transparent conductive coating, discussed in more detail below, and/or to facilitate adhesion of the components to the substrate (step 114). The pre-treatment may comprise a solvent or chemical washing, exposure to controlled levels of atmospheric humidity, heating, or surface treatments such as plasma treatment, UV-ozone treatment, or flame or corona discharge. Alternatively, or in combination, an adhesive (also called a primer or binder) may be deposited onto the surface of the substrate to further improve adhesion of the components to the substrate. Method 110 continues with the formation of a transparent conductive coating, such as transparent conductive coating 104 of FIG. 1, on the substrate (step 116).

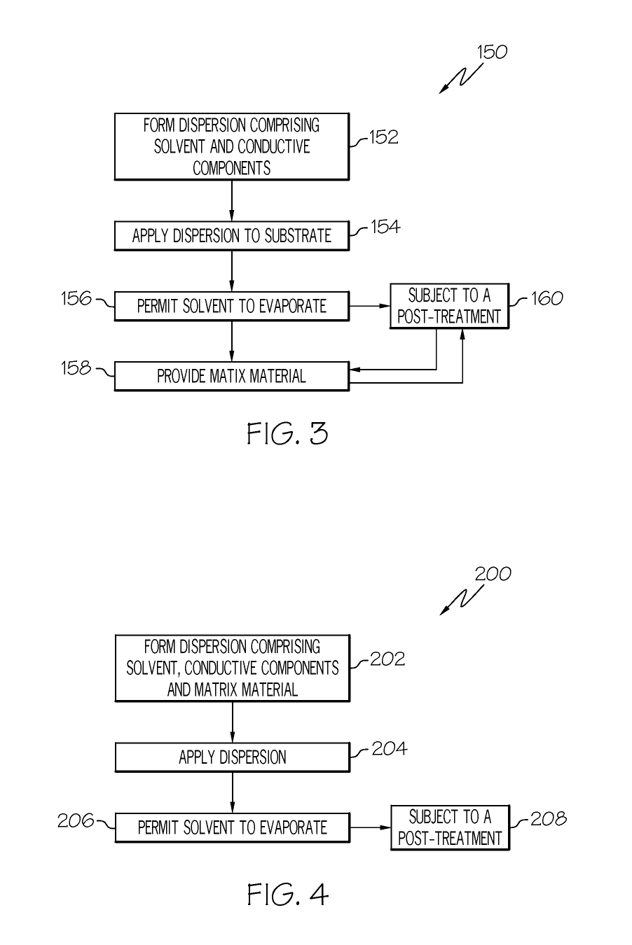

Referring to FIG. 3, in accordance with an exemplary embodiment of the present invention, the step of forming a transparent conductive coating on a substrate (step 116 of FIG. 2) comprises a process 150 for forming a transparent conductive coating on the substrate in which a plurality of conductive components are deposited on the substrate followed by providing a matrix overlying the conductive components. Process 150 begins by forming a dispersion (step 152). In one exemplary embodiment, the dispersion comprises at least one solvent and a plurality of conductive components. The conductive components are discrete structures that are capable of conducting electrons. Examples of the types of such conductive structures include conductive nanotubes, conductive nanowires, and any conductive nanoparticles, including metal and metal oxide nanoparticles, and conducting polymers and composites. These conductive components may comprise metal, metal oxide, polymers, alloys, composites, carbon, or combinations thereof, as long as the component is sufficiently conductive. One example of a conductive component is a discrete conductive structure, such as a metal nanowire, which comprises one or a combination of transition metals, such as silver (Ag), nickel (Ni), tantalum (Ta), or titanium (Ti). In a preferred embodiment of the present invention, the conductive components comprise silver nanowires, such as those available from Seashell Technology, Inc. of La Jolla, Calif. Other types of conductive components include multi-walled or single-walled conductive nanotubes and non-functionalized nanotubes and functionalized nanotubes, such as acid-functionalized nanotubes. These nanotubes may comprise carbon, metal, metal oxide, conducting polymers, or a combination thereof. Additionally, it is contemplated that the conductive components may be selected and included based on a particular diameter, shape, aspect ratio, or combination thereof. As used herein, the phrase “aspect ratio” designates that ratio which characterizes the average particle size or length divided by the average particle thickness or diameter. In one exemplary embodiment, conductive components contemplated herein have a high aspect ratio, such as at least 100:1. A 100:1 aspect ratio may be calculated, for example, by utilizing components that are 6 microns (μm) by 60 nm. In another embodiment, the aspect ratio is at least 300:1. In one exemplary embodiment of the invention, the conductive components comprise about 0.01% to about 14.0% by weight of the total dispersion. In a preferred embodiment of the invention, the conductive components comprise about 0.1% to about 0.6% by weight of the dispersion.

Solvents suitable for use in the dispersion comprise any suitable pure fluid or mixture of fluids that is capable of forming a solution with the conductive components and that may be volatilized at a desired temperature, such as the critical temperature. Contemplated solvents are those that are easily removed within the context of the applications disclosed herein. For example, contemplated solvents comprise relatively low boiling points as compared to the boiling points of precursor components. In some embodiments, contemplated solvents have a boiling point of less than about 250° C. In other embodiments, contemplated solvents have a boiling point in the range of from about 50° C. to about 250° C. to allow the solvent to evaporate from the applied film. Suitable solvents comprise any single or mixture of organic, organometallic, or inorganic molecules that are volatized at a desired temperature.

In some contemplated embodiments, the solvent or solvent mixture comprises aliphatic, cyclic, and aromatic hydrocarbons. Aliphatic hydrocarbon solvents may comprise both straight-chain compounds and compounds that are branched and possibly crosslinked. Cyclic hydrocarbon solvents are those solvents that comprise at least three carbon atoms oriented in a ring structure with properties similar to aliphatic hydrocarbon solvents. Aromatic hydrocarbon solvents are those solvents that comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, nitrated hydrocarbons, benzene, 1,2-dimethylbenzene, 1,2,4-trimethylbenzene, mineral spirits, kerosene, isobutylbenzene, methylnaphthalene, ethyltoluene, and ligroine.

In other contemplated embodiments, the solvent or solvent mixture may comprise those solvents that are not considered part of the hydrocarbon solvent family of compounds, such as ketones (such as acetone, diethylketone, methylethylketone, and the like), alcohols, esters, ethers, amides and amines. Contemplated solvents may also comprise aprotic solvents, for example, cyclic ketones such as cyclopentanone, cyclohexanone, cycloheptanone, and cyclooctanone; cyclic amides such as N-alkylpyrrolidinone, wherein the alkyl has from about 1 to 4 carbon atoms; N-cyclohexylpyrrolidinone and mixtures thereof.

Other organic solvents may be used herein insofar as they are able to aid dissolution of an adhesion promoter (if used) and at the same time effectively control the viscosity of the resulting dispersion as a coating solution. It is contemplated that various methods such as stirring and/or heating may be used to aid in the dissolution. Other suitable solvents include methylisobutylketone, dibutyl ether, cyclic dimethylpolysiloxanes, butyrolactone, γ-butyrolactone, 2-heptanone, ethyl 3-ethoxypropionate, 1-methyl-2-pyrrolidinone, propyleneglycol methyletheracetate (PGMEA), hydrocarbon solvents, such as mesitylene, toluene di-n-butyl ether, anisole, 3-pentanone, 2-heptanone, ethyl acetate, n-propyl acetate, n-butyl acetate, ethyl lactate, ethanol, 2-propanol, dimethyl acetamide, and/or combinations thereof.

The conductive components and solvent are mixed using any suitable mixing or stirring process that forms a homogeneous mixture. For example, a low speed sonicator or a high shear mixing apparatus, such as a homogenizer, a microfluidizer, a cowls blade high shear mixer, an automated media mill, or a ball mill, may be used for several seconds to an hour or more to form the dispersion. The mixing or stirring process should result in a homogeneous mixture without damage or change in the physical and/or chemical integrity of the conductive components. For example, the mixing or stirring process should not result in slicing, bending, twisting, coiling, or other manipulation of the conductive components that would reduce the conductivity of the resulting transparent conductive coating. Heat also may be used to facilitate formation of the dispersion, although the heating should be undertaken at conditions that avoid vaporization of the solvent. In addition to the conductive components and the solvent, the dispersion may comprise one or more functional additives. Examples of such additives include dispersants, surfactants, polymerization inhibitors, corrosion inhibitors, light stabilizers, wetting agents, adhesion promoters, binders, antifoaming agents, detergents, flame retardants, pigments, plasticizers, thickeners, viscosity modifiers, rheology modifiers, photosensitive and/or photoimageable materials, and mixtures thereof.

The next step in the method involves applying the dispersion onto the substrate to reach a desired thickness (step 154). The dispersion may be applied by, for example, brushing, painting, screen printing, stamp rolling, rod or bar coating, ink jet printing, slot-dye coating, or spraying the dispersion onto the substrate, dip-coating the substrate into the dispersion, rolling the dispersion onto substrate, or by any other method or combination of methods that permits the dispersion to be applied uniformly or substantially uniformly to the surface of the substrate. The dispersion may be applied in one layer or may be applied in multiple layers overlying the substrate.

The solvent of the dispersion then is permitted to at least partially evaporate so that the dispersion has a sufficiently high viscosity so that the conductive components are no longer mobile in any remaining dispersion on the substrate, do not move under their own weight when subjected to gravity, and are not moved by surface forces within the dispersion (step 156). In one exemplary embodiment, the dispersion may be applied by a conventional rod coating technique and the substrate may be placed in an oven, optionally using forced air, to heat the substrate and dispersion and thus evaporate the solvent. In another example, the solvent may be evaporated at room temperature (15° C. to 27° C.). In another example, the dispersion may be applied to a heated substrate by airbrushing the precursor onto the substrate at a coating speed that allows for the evaporation of the solvent. If the dispersion comprises a binder, an adhesive, or other similar polymeric compound, the dispersion also may be subjected to a temperature that will cure the compound. The curing process may be performed before, during, or after the evaporation process.

In an exemplary embodiment of the present invention, after at least partial evaporation of the solvent from the dispersion, the resulting transparent conductive coating may be subjected to a post-treatment to improve the transparency and/or conductivity of the coating (step 160). In one exemplary embodiment, the post-treatment includes treatment with an alkaline, including treatment with a strong base. Contemplated strong bases include hydroxide constituents, such as sodium hydroxide (NaOH). Other hydroxides which may be useful include lithium hydroxide (LiOH), potassium hydroxide (KOH), ammonium hydroxide (NH₃OH), calcium hydroxide (CaOH), or magnesium hydroxide (MgOH). Alkaline treatment may be at pH greater than 7, more specifically at pH greater than 12. Without wishing to be bound by theory, one reason this post-treatment may improve the transparency and/or conductivity of the resulting transparent conductive coating may be that a small but useful amount of oxide is formed on the surface of the conductive components, which beneficially modifies the optical properties and conductivity of the conductive components network by forming an oxide film of favorable thickness on top of the conductive components. Another explanation for the improved performance may be that contact between the conductive components is improved as a result of the treatment, and thereby the overall conductivity of the conductive components network is improved. Oxide scale formation may result in an overall expansion of the dimensions of the conductive components and, if the conductive components are otherwise held in a fixed position, may result in a greater component-to-component contact. Another mechanism by which the conductivity could improve is via the removal of any residual coating or surface functional groups that were formed or placed on the conductive components during either component synthesis or during formation of the conductive coating. For example, the alkaline treatment may remove or reposition micelles or surfactant coatings that are used to allow a stable conductive components dispersion as an intermediate process in forming the conductive nanowire coatings. The alkaline may be applied by, for example, brushing, painting, screen printing, stamp rolling, rod or bar rolling, inkjet printing, or spraying the alkaline onto the transparent conductive coating, dip-coating the coating into the alkaline, rolling the alkaline onto coating, or by any other method or combination of methods that permits the alkaline to be applied substantially uniformly to the transparent conductive coating. In another exemplary embodiment of the invention, it will be understood that the alkaline may be added to the dispersion before application to the substrate. Other finishing steps for improving the transparency and/or conductivity of the transparent conductive coating include oxygen plasma exposure and corona discharge exposure. For example, suitable plasma treatment conditions are about 250 mTorr of O₂ at 100 to 250 watts for about 30 seconds to 20 minutes in a commercial plasma generator. The transparent conductive coating also may be subjected to a pressure treatment during which the conductive components are pressed closely together, forming a network that results in an increase in the conductivity of the resulting transparent conductor.

A matrix material then is provided overlying the conductive components disposed on the substrate to the quarter-wave thickness “d” (step 158). The matrix material may comprise one material layer or may comprise more than one layer, each comprising the same or different materials, so that the resulting transparent conductive coating 104 has an effective refractive index “n₂” defined by the equation n₂=\sqrt{n₁×n₃}±Δ, that is, it is tuned to a future application where it will be used in a multilayer stack between the transparent substrate with a refractive index n₁ and a second layer with a refractive index n₃. The matrix material may be any suitable material having a transmissivity no less than about 50%. Materials with a refractive index of about \sqrt{1.5}, or about 1.2 to about 1.3, are anti-reflective materials that exhibit superior transmissivity. Accordingly, in one exemplary embodiment, if the substrate and the over layer are selected so that the product of their effective refractive indices approaches 1.5, the matrix material may be selected so that the refractive index n₂ of the transparent conductive coating 104 approaches \sqrt{n₁×n₃}. If production parameters are controlled such that Δ approaches 0, a transparent conductor with minimal scattering and optimal transmissivity may be achieved. In one exemplary embodiment, the substrate is a glass having an effective refractive index of about 1.5. In another exemplary embodiment of the invention, the matrix material is a glass having a refractive index of 1.5. In a further exemplary embodiment, the matrix is a gas, such as air that has a refractive index of about 1. In yet another exemplary embodiment of the invention, the matrix material is a silicon dioxide, which has a refractive index of about 1.46. The silicon dioxide may be formed by plasma deposition, thermal oxidation of a deposited silicon layer, or other suitable method.

In another exemplary embodiment, the matrix material is an organosilicate that may be applied to the conductive components, such as by brushing, painting, screen printing, stamp rolling, rod or bar rolling, inkjet printing, or spraying the organosilicate onto the transparent conductive coating, dip-coating the coating into the organosilicate, slot-die rolling the organosilicate onto coating, or by any other method or combination of methods that permits the organosilicate to be applied substantially uniformly to the transparent conductive coating. Examples of organosilicate materials suitable for use include silsesquioxanes or silazane compounds, such as, for example, methylsiloxane, methylsilsesquioxane, phenylsiloxane, phenylsilsesquioxane, and the like, and mixtures thereof. Other materials suitable for use as the matrix material include fluoride oxide-based glasses. Depending on the matrix material, the matrix material may be cured, such as by air drying, by subjecting the layer to heat, or by another suitable method. If not performed after evaporation of the solvent, or in addition to being performed after evaporation of the solvent, the resulting transparent conductive coating may be subjected to a post-treatment, such as the post-treatments described above with reference to step 160, to further enhance the conductivity and/or transmissivity of the coating.

Referring to FIG. 4, in accordance with an alternative exemplary embodiment of the present invention, the step of forming a transparent conductive coating on a substrate (step 116 of FIG. 2) comprises a process 200 for forming a transparent conductive coating on the substrate in which a plurality of conductive components are interspersed within the matrix material, which is then deposited on the substrate. Process 200 begins by forming the dispersion (step 202). In one exemplary embodiment, the dispersion comprises at least one solvent, a plurality of conductive components, and a matrix material. The solvent may comprise any of the solvents described above with respect to FIG. 3, the conductive components may comprise any of the conductive components described above with respect to FIG. 3, and the matrix material may comprise any of the matrix materials described above with respect to FIG. 3, except for air.

The dispersion then is applied to the substrate to a thickness such that, after evaporation of the solvent, as described below, the resulting transparent conductive coating 104 has a quarter-wave thickness “d” (step 204). The dispersion may be applied by, for example, brushing, painting, screen printing, stamp rolling, rod or bar coating, ink jet printing, or spraying the dispersion onto the substrate, dip-coating the substrate into the dispersion, slot-die rolling the dispersion onto substrate, or by any other method or combination of methods that permits the dispersion to be applied uniformly or substantially uniformly to the surface of the substrate. The dispersion may be applied in one layer or may be applied in multiple layers overlying the substrate.

The solvent of the dispersion then is permitted to at least partially evaporate so that the dispersion has a sufficiently high viscosity so that the conductive components are no longer mobile in any remaining dispersion on the substrate, do not move under their own weight when subjected to gravity, and are not moved by surface forces within the dispersion (step 206). In one exemplary embodiment, the substrate may be placed in an oven, optionally using forced air, to heat the substrate and dispersion and thus evaporate the solvent. In another example, the solvent may be evaporated at room temperature (15° C. to 27° C.). In another example, the dispersion may be applied to a heated substrate by airbrushing the precursor onto the substrate at a coating speed that allows for the evaporation of the solvent. If the matrix material is to be cured, and/or if dispersion comprises a binder, an adhesive, or other similar polymeric compound, the dispersion also may be subjected to a temperature that will cure the compound. The curing process may be performed before, during, or after the evaporation process.

In an exemplary embodiment of the present invention, after at least partial evaporation of the solvent from the dispersion, the resulting transparent conductive coating may be subjected to a post-treatment to improve the transparency and/or conductivity of the coating (step 208). Any of the post-treatments described above with respect to step 160 of FIG. 3 may be used.

Referring back to FIG. 2, after formation of the transparent conductive coating on the substrate, the over layer having a refractive index n₃, such as over layer 106 of FIG. 1, is formed overlying the transparent conductive coating (step 118). The over layer may be any layer of a display device that is designed to overlie the transparent conductor, as described in more detail below. For example, the over layer may comprise a protective, relatively transparent layer formed of a polymer, glass, ceramic, or the like. Alternatively, the over layer may comprise a plurality of sub-layers that, combined, have an effective refractive index n₃. For example, the over layer may comprise layers of a liquid crystal display. In another alternative embodiment, the over layer may comprise air.

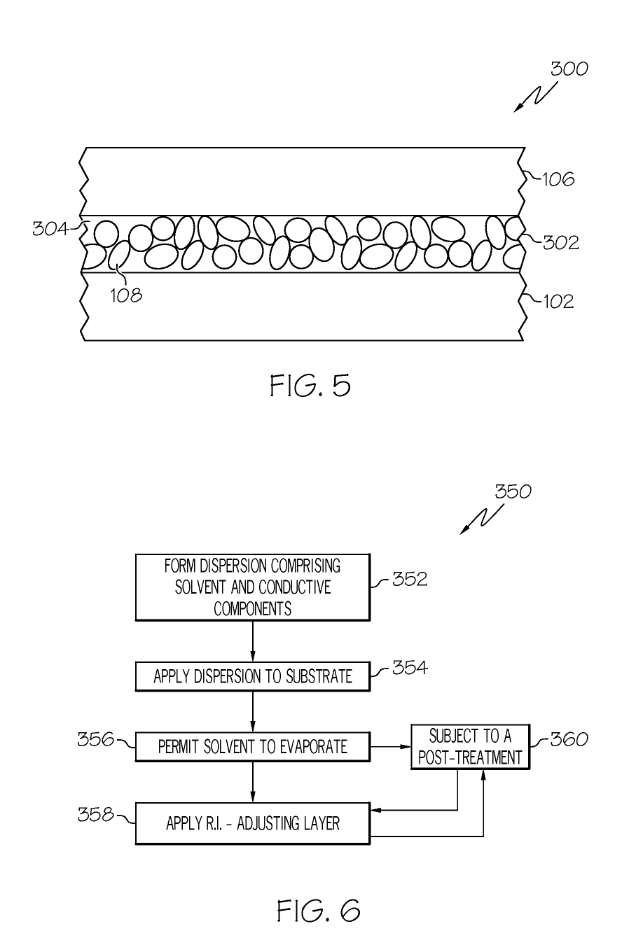

A transparent conductor 300 in accordance with another exemplary embodiment of the present invention is illustrated in FIG. 5. Transparent conductor 300 is similar to transparent conductor 100 of FIG. 1. In one exemplary embodiment of the invention, the transparent conductor 300 has a total light transmittance of no less than about 50%. In another exemplary embodiment of the invention, the transparent conductor 300 has a surface resistivity in the range of about 10¹ to about 10¹² ohms/square (Ω/sq). In another exemplary embodiment of the invention, the transparent conductor 100 has a surface resistivity in the range of about 10¹ to about 10³ Ω/sq. In this regard, the transparent conductor 300 may be used in various applications such as flat panel displays, touch panels, thermal control films, microelectronics, and the like. Transparent conductor 300 also is similar to transparent conductor 100 to the extent that it exhibits minimal scattering, thus minimizing haze apparent in the conductor. However, transparent conductor 300 differs from transparent conductor 100 to the extent that transparent conductor 300 comprises a transparent conductive coating 302 that comprises conductive components 108 and a matrix material that is a refractive-index (R.I.)-adjusting material 304. Similar to the matrix material disclosed above, the R.I.-adjusting material 304 is such that the transparent conductive coating 302 has refractive index n₂ in a range indicated by the equation (3):

\sqrt{n₁×n₃}−Δ≦n₂≦\sqrt{n₁×n₃}+Δ (3),

where Δ is the optimization factor described above. In this regard, while the transparent conductive coating 302 may not be a quarter-wave layer, scattering may be minimized by using a refractive-index adjusting layer that attempts to compromise the refractive indices of the layers adjacent to its opposing sides. However, it will be understood that, in an exemplary embodiment of the invention, the transparent conductive coating 302 may be a quarter-wave layer having a quarter-wave thickness “d”.

The method 110 of FIG. 2 for fabricating transparent conductor 100 also may be used to fabricate a transparent conductor such as transparent conductor 300 of FIG. 5. Referring to FIG. 2, the method of fabricating transparent conductor 300 includes the step of providing a substrate (step 112). Any of the substrates described above may be utilized in the fabrication of transparent conductor 300. The substrate then may be subjected to pretreatment such as, for example, any of the pretreatments discussed above (step 114). A transparent conductive coating then is formed on the substrate (step 116). Referring to FIG. 6, in accordance with an exemplary embodiment of the present invention, the step of forming the transparent conductive coating on the substrate comprises a process 350 for forming a transparent conductive coating on the substrate in which a plurality of conductive components are deposited on the substrate followed by the application of the R.I.-adjusting layer. Process 350 begins by forming a dispersion (step 352). In one exemplary embodiment, the dispersion comprises at least one solvent and a plurality of conductive components. Any of the solvents and conductive components described above with reference to the dispersion of FIG. 3 may be utilized in the dispersion of step 352. The dispersion also may comprise any of the functional additives set forth above. The dispersion is applied to the substrate (step 354), the solvent of the dispersion is permitted to at least partially evaporate (step 356), and the conductive components may be subjected to a post-treatment (step 360), using methods such as those respective methods described above.

A refractive index (R.I.)-adjusting layer then is deposited overlying the conductive components remaining on the substrate layer (step 358). As described in more detail below, an over layer having an effective refractive index n₃, such as over layer 106 of FIG. 5, is disposed overlying the R.I.-adjusting layer once the R.I.-adjusting layer is formed on the conductive components. Accordingly, the R.I.-adjusting layer comprises a material such that the resulting transparent conductive coating has a refractive index defined by the equation:

\sqrt{n₁×n₃}−Δ≦n₂≦\sqrt{n₁×n₃}+Δ,

where Δ is the optimization factor discussed above. The R.I.-adjusting layer may comprise one material layer or more than one layer, each comprising the same or different materials that, combined, have an effective refractive index n₂. The R.I.-adjusting layer serves to reduce the scattering of light through the transparent conductor, thus enhancing the optical properties of the transparent conductor. The R.I.-adjusting layer may comprise, for example, an organic or non-organic silica-comprising material. Examples of organosilicate materials include silsesquioxanes or silazane compounds, such as, for example, methylsiloxane, methylsilsesquioxane, phenylsiloxane, phenylsilsesquioxane, and the like, and mixtures thereof, that may be applied overlying the conductive components by, for example, brushing, painting, screen printing, stamp rolling, rod or bar rolling, inkjet printing, or spraying the organosilicate onto the transparent conductive coating, dip-coating the coating into the organosilicate, slot-die rolling the organosilicate onto coating, or by any other method or combination of methods that permits the organosilicate to be applied substantially uniformly to the transparent conductive coating. Examples of non-organic silica-comprising materials include silicon dioxide that may be deposited overlying the conductive components by plasma vapor deposition (PVD), chemical vapor deposition (CVD), thermal oxidation of deposited silicon layers, and the like. Depending on the R.I.-adjusting material used, the R.I.-adjusting layer may be cured, such as by air drying, by subjecting the layer to heat, or by another suitable method. If not performed after evaporation of the solvent, or in addition to being performed after evaporation of the solvent, the resulting transparent conductive coating may be subjected to a post-treatment to further enhance the conductivity and/or transmissivity of the coating.

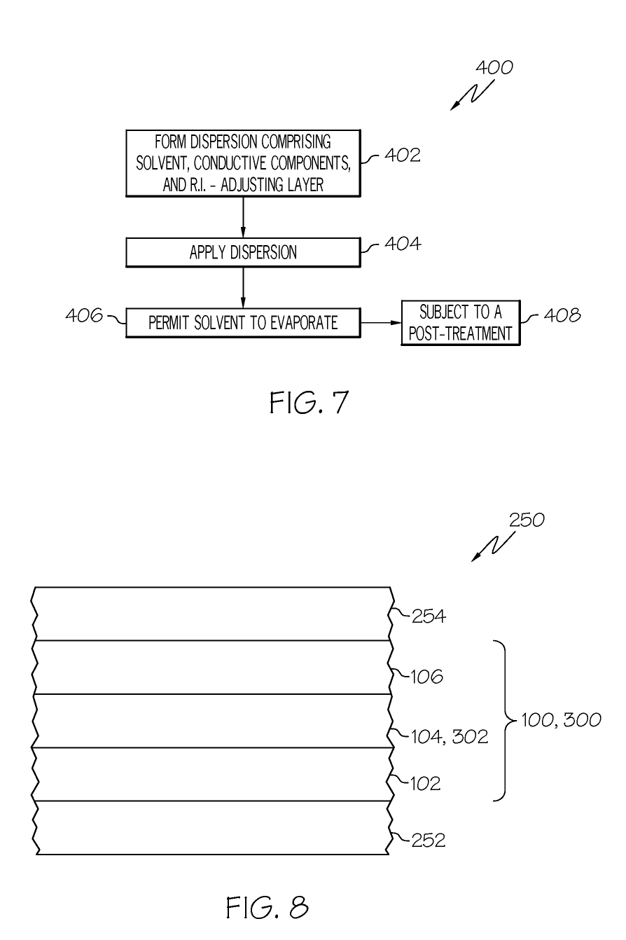

Referring to FIG. 7, in accordance with an alternative exemplary embodiment of the present invention, the step of forming the transparent conductive coating on the substrate of FIG. 5 comprises a process 400 for forming a transparent conductive coating on the substrate in which a plurality of conductive components are interspersed within the R.I.-adjusting layer, which is then deposited on the substrate. Process 400 begins by forming a dispersion (step 202). In one exemplary embodiment, the dispersion comprises at least one solvent, a plurality of conductive components, and an R.I.-adjusting material. The solvent, the conductive components, and the R.I.-adjusting material may comprise any of those respective materials described above with respect to FIG. 6.

The dispersion is applied to substrate to a desired thickness (step 404). The dispersion may be applied by, for example, brushing, painting, screen printing, stamp rolling, rod or bar coating, ink jet printing, or spraying the dispersion onto the substrate, dip-coating the substrate into the dispersion, slot-die rolling the dispersion onto substrate, or by any other method or combination of methods that permits the dispersion to be applied uniformly or substantially uniformly to the surface of the substrate. The dispersion may be applied in one layer or may be applied in multiple layers overlying the substrate.

The solvent of the dispersion then is permitted to at least partially evaporate so that any remaining dispersion has a sufficiently high viscosity so that the conductive components are no longer mobile in the dispersion on the substrate, do not move under their own weight when subjected to gravity, and are not moved by surface forces within the dispersion (step 406). In one exemplary embodiment, the substrate may be placed in an oven, optionally using forced air, to heat the substrate and dispersion and thus evaporate the solvent. In another example, the solvent may be evaporated at room temperature (15° C. to 27° C.). In another example, the dispersion may be applied to a heated substrate by airbrushing the precursor onto the substrate at a coating speed that allows for the evaporation of the solvent. If the R.I.-adjusting layer is to be cured, and/or if dispersion comprises a binder, an adhesive, or other similar polymeric compound, the dispersion also may be subjected to a temperature that will cure the compound. The curing process may be performed before, during, or after the evaporation process.

In an exemplary embodiment of the present invention, after at least partial evaporation of the solvent from the dispersion, the resulting transparent conductive coating may be subjected to a post-treatment to improve the transparency and/or conductivity of the coating (step 408). Any of the post-treatments described above with respect to step 160 of FIG. 3 may be used.

Referring back to FIG. 2, after formation of the transparent conductive coating on the substrate, the over layer having an effective refractive index n₃, such as over layer 106 of FIG. 1 and FIG. 5, is formed overlying the transparent conductive coating, as described above (step 118).

The transparent conductor 100 of FIG. 1 and the transparent conductor 300 of FIG. 5 may be utilized in a display device 250, as illustrated in FIG. 8. The display device 250 comprises a first functional layer 252 upon which the transparent conductor 100 or 300 is disposed. The first functional layer may comprise one functional layer or a number of functional sub-layers. The first functional layer 252, either as one layer or a number of sub-layers, layers, is configured to perform a function that corresponds to the overall function of display device 250. For example, if display device 250 is a touch panel display, first functional layer 252 may comprise a liquid crystal display device. In another exemplary embodiment, the first functional layer 252 may be a polarizer. In yet another exemplary embodiment, first functional layer 252 may simply provide support for transparent conductor 100, 300. The display device 250 also comprises a second functional layer 254 that is disposed upon transparent conductor 100 or 300. Similar to the first functional layer, the second functional layer may comprise one functional layer or a number of functional sub-layers. The second functional layer 254, either as one layer or a number of sub-layers, also is configured to perform a function that corresponds to the overall function of display device 250. For example, if display device 250 is a touch panel display, second functional layer 252 may comprise a flexible hard-coated outer membrane. In another exemplary embodiment, the second functional layer 252 is the over layer 106 of transparent conductor 100 or 300. In yet another exemplary embodiment, the second functional layer may simply serve as a transparent protective covering for the transparent conductor 100 or 300.

Accordingly, transparent conductors that exhibit minimal scattering and, hence, minimal haze, have been provided. In addition, methods for fabricating such transparent conductors and display devices that utilize such transparent conductors have been provided. While at least one exemplary embodiment has been presented in the foregoing detailed description of the invention, it should be appreciated that a vast number of variations exist. The foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A transparent conductor comprising:
a substrate having an effective refractive index n₁;
an over layer overlying the substrate and having an effective refractive index n₃;
a transparent conductive coating interposed between the substrate and the over layer, the transparent conductive coating comprising a plurality of conductive components and a matrix material that together have an effective refractive index n₂ in the range of about \sqrt{n₁×n₃}−Δ≦n₂≦\sqrt{n₁×n₃}+Δ, wherein Δ is an optimization factor within the range of about 0 to about 0.3.

2. The transparent conductor of claim 1, wherein the plurality of conductive components are dispersed throughout the matrix material.

3. The transparent conductor of claim 1, wherein the matrix material overlies the plurality of conductive components.

4. The transparent conductor of claim 1, wherein the matrix material comprises silicon dioxide.

5. The transparent conductor of claim 1, wherein the matrix material comprises an organosilicate.

6. The transparent conductor of claim 1, wherein the plurality of conductive components comprises a plurality of metal nanowires.

7. The transparent conductor of claim 1, wherein the plurality of conductive components comprises a plurality of carbon nanotubes.

8. The transparent conductor of claim 1, wherein the transparent conductive coating is a quarter-wave layer corresponding to a wavelength in a spectral interval of from about 380 nm to about 780 nm.

9. The transparent conductor of claim 8, wherein the transparent conductive coating is a quarter-wave layer corresponding to a wavelength in a spectral interval of from about 380 nm to about 460 nm.

10. A method for fabricating a transparent conductor, the method comprising the steps of:
providing a substrate having an effective refractive index n₁;
forming a transparent conductive coating on the substrate, wherein the transparent conductive coating comprises a plurality of conductive components and a matrix material; and
forming an over layer overlying the plurality of conductive components and the matrix material, wherein the over layer has an effective refractive index n₃, wherein the transparent conductive coating has an effective refractive index n₂ in the range of about \sqrt{n₁×n₃}−Δ≦n₂≦\sqrt{n₁×n₃}+Δ, and wherein Δ is an optimization factor in the range of about 0 to about 0.3.

11. The method of claim 10, wherein the step of forming a transparent conductive coating comprises the steps of:
forming a dispersion comprising the plurality of conductive components and a solvent;
applying the dispersion to the substrate;
permitting the solvent to at least partially evaporate; and
forming the matrix material overlying the substrate and the plurality of conductive components.

12. The method of claim 10, further comprising the step of subjecting the plurality of conductive components to a post-treatment before the step of forming an over layer.

13. The method of claim 10, wherein the step of forming a transparent conductive coating comprises the steps of:
forming a dispersion comprising the plurality of conductive components, the matrix material, and a solvent;
applying the dispersion to the substrate; and
permitting the solvent to at least partially evaporate.

14. The method of claim 10, wherein the substrate comprises a glass having an effective refractive index of about 1.5.

15. The method of claim 10, wherein the over layer comprises a glass having an effective refractive index of about 1.5.

16. The method of claim 10, wherein the step of forming a transparent conductive coating comprises forming the transparent conductive coating such that it is a quarter-wave layer corresponding to a wavelength in a spectral interval of from about 380 nm to about 780 nm.

17. The method of claim 16, wherein the step of forming a transparent conductive coating comprises forming the transparent conductive coating such that it is a quarter-wave layer corresponding to a wavelength in a spectral interval of from about 380 nm to about 460 nm.

18. A display device comprising:
a first functional layer;
a second functional layer; and
a transparent conductor interposed between the first functional layer and the second functional layer, wherein the transparent conductor comprises:
a substrate having an effective refractive index n₁;
an over layer overlying the substrate and having an effective refractive index n₃; and
a transparent conductive coating interposed between the substrate and the over layer, wherein the transparent conductive coating comprises a plurality of conductive components and a material that together have an effective refractive index n₂ in the range of about \sqrt{n₁×n₃}−Δ≦n₂≦\sqrt{n₁×n₃}+Δ, wherein Δ is an optimization factor in the range of about 0 to about 0.3.

19. The display device of claim 18, wherein the transparent conductive coating is a quarter-wave layer corresponding to a wavelength in a spectral interval of from about 380 nm to about 780 nm.

20. The display device of claim 19, wherein the transparent conductive coating is a quarter-wave layer corresponding to a wavelength in a spectral interval of from about 380 nm to about 460 nm.
